(19) United States
(12) Patent Application Publication
(10) Pub. No.: US 2010/0077564 A1
(43) Pub. Date: Apr. 1, 2010

(54) HINGE APPARATUS TO FACILITATE POSITION ADJUSTMENT OF EQUIPMENT

(75) Inventors: Mohammed Saier, Sannyvale, CA (US); Jean-Michel Thiers, Sunnyvale, CA (US); John Fisher, Los Gatos, CA (US)

Correspondence Address: PERKINS COIE LLP, P.O. BOX 1208, SEATTLE, WA, 98111-1208, US

(73) Assignee: Espresso Fitness Corp., Sunnyvale, CA (US)

(21) Appl. No.: 12/242,680

(22) Filed: Sep. 30, 2008

Related U.S. Application Data
(60) Provisional application No. 61/101,117, filed on Sep. 29, 2008.
(60) Provisional application No. 61/101,114, filed on Sep. 29, 2008.

(51) Int. Cl. E05F 1/10; A63B 69/16; E05D 7/04

(52) U.S. Cl. 16/277; 482/57; 16/303; 16/242

(57) ABSTRACT

A hinge apparatus to facilitate equipment position adjustment is disclosed. One embodiment of a system includes, a hinge apparatus having a through-hole, a rotate-able portion and a body portion. The system further includes, equipment having a first portion coupled to the rotate-able portion of the hinge apparatus, a second portion coupled to the body portion of the hinge apparatus, and an electrical wire that facilitates function of the equipment. The electrical wire is disposed in the hinge extending through the through-hole. The hinge apparatus is operatively configured such that the electrical wire remains intact during when the rotate-able portion of the hinge rotates.

### CLAIM OF PRIORITY

This application claims priority to U.S. Provisional Patent Application No. 61/101,117 entitled “A HINGE APPARATUS TO FACILITATE POSITION ADJUSTMENT OF EQUIPMENT”, which was filed on Sep. 29, 2008, the contents of which are expressly incorporated by reference herein.

This application claims priority to U.S. Provisional Patent Application No. 61/101,114 entitled “EXERCISE EQUIPMENT WITH A (RE) PROGRAMMABLE UNIT”, which was filed on Sep. 29, 2008, the contents of which are expressly incorporated by reference herein.

### FIELD OF TECHNOLOGY

The technology relates to an apparatus for adjusting the position of associated equipment. More specifically, it relates to apparatuses to facilitate assembly and/or re-assembly of fitness/exercise equipments.

### BACKGROUND

Fitness equipments are ubiquitous in homes and fitness clubs. Due to the complexity of functions and the mechanical strength of the equipment necessary to withstand professional exercise, exercise equipments are typically not portable in the same sense as smaller exercise machines for home use are made. Portable exercise equipment is designed for easy lifting and storage in one's home. Such equipment is sometimes made foldable to reduce its overall size (dimensions) so it can fit within a closet or other storage place. However, portable and easy-to-lift home exercise stations are light, have limited strength, and do not offer advanced features present in today's state of the art exercise equipment. There is generally no need for temporary storage of club-grade exercise equipments.

Besides the entertainment and exercise value exercise equipment can offer, the other important attributes of the equipment in which the owner, typically a fitness club, is interested are the price of the equipment, the ease of installation, and maintenance. Fitness clubs generally order multiple units of fitness equipment units and prefer to spend less amount of time installing and maintaining these units. At the same time, the exercise-equipment-manufacturer's objective is to decrease the cost of installation, maintenance, and shipping. However, the shipping cost and the desire for plug-and-play equipment are typically contradicting. For example, shipping a completely assembled station is more expensive than shipping a station in parts due to the size of the unit, while shipping a disassembled station requires substantial effort in assembly by the owner.

Additionally, assembly in the field by unqualified personnel increases the opportunity for error and may incur additional costs for the manufacturer. Exercise equipment for professional use in fitness clubs and by athletes for training is progressively increasing in complexity in terms of hardware and software features. This results in more mechanical parts and electronics that need to be assembled and integrated. As technology progresses, the requirements on strength and size of professional and high-end exercise equipment are not. In fact, the strength requirements on the frame are increasing due to more professionals using such equipment and many users in fitness clubs. The size of the equipment is not reducing because the average person size does not perceptibly change.

### BRIEF DESCRIPTION OF THE DRAWINGS

FIG. 1A illustrates an example of an exercise equipment having a hinge assembly, the exercise equipment positioned in a first position that is suitable for operation exercise equipment, according to one embodiment.

FIG. 1B illustrates an example of an exercise equipment having a hinge assembly, the exercise equipment positioned in a second position, according to one embodiment.

FIG. 2A depicts the physical configuration of a hinge assembly that enables equipment position adjustment of an equipment, the hinge is positioned in a first hinge position that is suitable for operation of the equipment, according to one embodiment.:

FIG. 2B depicts the physical configuration of a hinge assembly positioned in a second hinge position configured to place the equipment in a second position, according to one embodiment.

FIG. 3A depicts a further view of an example of the hinge assembly in a first hinge position that is suitable for operation of the equipment, according to one embodiment.

FIG. 3B depicts a further view of an example of the hinge assembly positioned in a second hinge position that is suitable for at least partially disassembling the equipment, according to one embodiment.

FIG. 4 depicts an exploded view of an example of the hinge assembly, according to one embodiment.

FIG. 5A depicts another view of an example equipment having the hinge assembly in a first hinge position that is suitable for operation of the equipment, according to one embodiment.

FIG. 5B depicts another view of the example equipment having a hinge assembly in a second hinge position that is suitable for at least partially disassembling the equipment, according to one embodiment.

FIG. 6 illustrates an example process flow for equipment assembly using a hinge, according to one embodiment.

FIG. 7 illustrates an example process flow for equipment de-assembly using a hinge, according to one embodiment.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Embodiments of the present disclosure include a hinge apparatus to facilitate equipment position adjustment, for example, for assembly and/or disassembly.

In general, the position of the equipment can be adjusted via the hinge apparatus/assembly for any known and/or convenient reason. For example, the position of the equipment can be adjusted into one or more of several operating positions. The various operating positions may be suitable for operators of different strengths or sizes.

In one embodiment, the position of the equipment can be adjusted/(re)configured for assembly, reassembly, and/or disassembly purposes. For example, the equipment may be assembled or reassembled when received as a packaged item or when retrieved from storage. The equipment may also be disassembled for any reduced-dimension purpose, including but not limited to, storage, packaging, and/or shipping. Note that in general, the configuration adjustment of the equipment into a position that is suitable for packaging, storage, and/or shipping by way of the hinge apparatus decreases the size of the requisite storage area/space or size/complexity of shipping material.

It is appreciated that although description of the hinge apparatus is applied to position adjustment of exercise equipment/fitness equipment, the novel art of the disclosure related to the hinge apparatus can be applied to adjust the position of any suitable equipment, in particular, equipment with electrical connectivity, for the same and/or similar purposes.

The exercise equipment may be any equipment including but not limited to, cardio-fitness equipment, bicycles, steppers, elliptical trainers, treadmills, and/or rowers, etc.

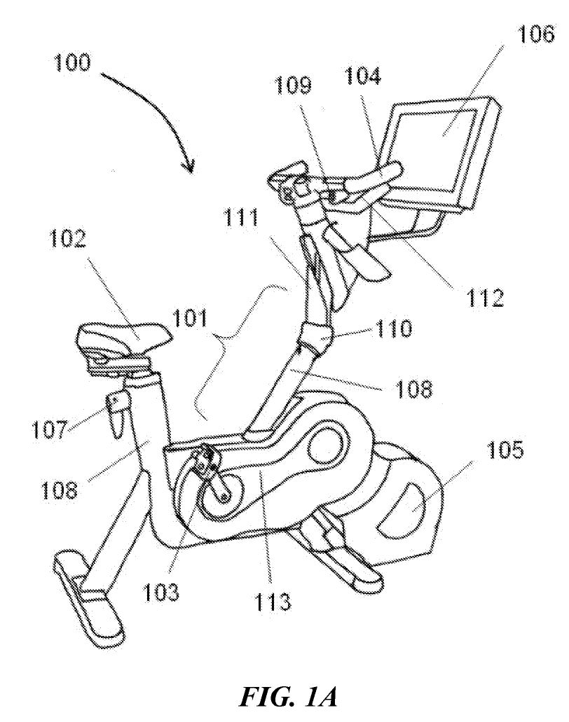

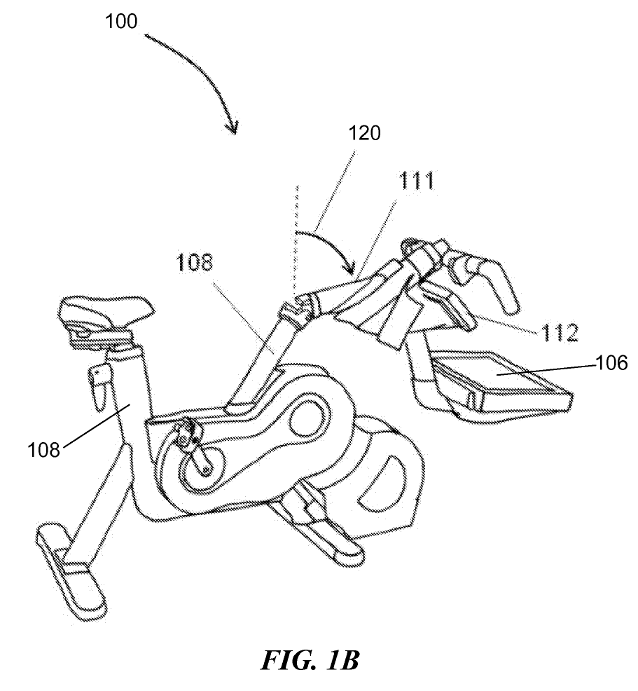

FIG. 1A illustrates an example of an exercise equipment 100 having a hinge assembly 110, the exercise equipment positioned in a first position that is suitable for operation, according to one embodiment.

In one embodiment, the exercise equipment 100 can include handlebars 104 and a seat 102 which can optionally be secured via a seat lock 107. Depending on the type of equipment, the exercise equipment 100 typically also includes a foot actuated apparatus including but not limited to a stepper, pedals, or the like assembly. In the example of a bicycle, the exercise equipment 100 includes pedals (shown in figure) 103 which is optionally enclosed with a drive train enclosure 113.

The exercise equipment 100 may further include, one or more gear shifting units 109, a keypad 112, and/or a handlebar 104 to control the hardware and/or software operations of the equipment 100. In one embodiment, the exercise equipment 100 is enabled with virtual reality capabilities and further includes a computing unit 105 and a display device 106 to provide the virtual reality experience. The handlebar 104 may be steer-able.

In one embodiment, the components of the exercise equipment 100 can be coupled to a frame 101, for example, via mechanical or electrical connections. In one embodiment, the frame 101 has a second portion 108 that is configured for resting on the floor and a first portion 111 that may be movable (e.g., rotate-able) to facilitate position adjustment of the exercise equipment 100.

For example, the first portion 111 of the exercise equipment 100 may be able to rotate or move towards the second portion 108 of the exercise equipment 100 into a second position as all or a part of the process for position adjustment for disassembly of the equipment 100. The first portion 111 may further be able to fold upwards away from the second portion 108 into a first position as a part of the process for position adjustment, for example, for assembly purposes. The first position is typically a position where the exercise equipment 100 is suitable for operation or usage.

In one embodiment, the second portion 108 and the first portion 111 are coupled to each other via a hinge apparatus/assembly 110 (note that in the example of FIG. 1A, the hinge is shown to be covered with an enclosure). A hinge typically refers to a type of bearing that can connect two objects and allow a predetermined angle of rotation between them. Two objects that are coupled via the hinge 110 can rotate relative to each other about an axis of rotation which is also referred to as the geometrical axis of the hinge. The hinge 110 may be made of any known or convenient material and components including but not limited to, stainless steel, flexible material, moving components, and the like.

In an example situation when the exercise equipment 100 is to be shipped from one location to another or placed in storage, packing of the exercise equipment 100 in the position illustrated in FIG. 1A can be tedious due to the large size (e.g., length and/or height) and the shape of the exercise equipment 100.

The hinge apparatus 110 and the rotational mechanisms introduced by the hinge 110 allows the exercise equipment 100 shown in FIG. 1A to be folded to one or more different positions having a lesser height and/or lesser length, for example, the second position illustrated in the example of FIG. 1B. For example, the first portion 111 of the equipment is rotate-able between at least two positions comprising a first position and a second position. The equipment 100 typically has a reduced dimension when in the second position relative to when in the first position.

In an example situation when the exercise equipment 100 is to be shipped from one location to another or placed in storage, packing of the exercise equipment 100 in the position illustrated in FIG. 1A can be tedious due to the large size (e.g., length and/or height) and the shape of the exercise equipment 100. In one embodiment, the hinge apparatus 110 enables the exercise equipment 100 to be arranged in one or more other positions having a lesser height and/or length. For example, the exercise equipment 100 may be folded via the hinge 110 into a configuration with lesser height. The exercise equipment 100 can then be packaged or otherwise stored in the one or more other positions via the folding mechanism provided by the hinge 110.

FIG. 1B illustrates an example of an exercise equipment 100 having a hinge assembly 110, the exercise equipment positioned in a second position, according to one embodiment.

The hinge 110 allows the first portion 111 of the exercise equipment 100 to move or rotate (e.g., towards the second portion 108/away from the seat 102) thereby reducing the overall height of the equipment 100 as is shown in FIG. 1B. The exercise equipment 100 may have an increased dimension when in the second position relative to when in the first position. In one embodiment, the first portion 111 of the exercise equipment 100 together with the handlebars 104 and the display device 106 is moved (e.g., rotated and/or folded) in the direction indicated by the arrow 120. Similarly, lesser or more components may be moved/rotated in conjunction with the first portion 111.

To restore the position of the exercise equipment 100 into the first position that is generally suited for operation, for example, the position illustrated in FIG. 1A, the hinge 110 may also be used to allow the first portion 111 to move upwards (e.g., rotate and/or fold) and away from the second portion 108. The hinge 110 may be covered with a plastic cover for aesthetic reasons.

One embodiment of an exercise apparatus includes, a hinge apparatus having a through-hole, the hinge apparatus comprising a rotate-able portion and a body portion. The exercise apparatus may further include, cardio-fitness equipment having, a first portion coupled to the rotate-able portion of the hinge apparatus, a second portion coupled to the body portion of the hinge apparatus, and an electrical wire that facilitates function of the cardio-fitness equipment. In one embodiment, the hinge apparatus is operatively configured such that the electrical wire remains intact when the rotate-able portion of the hinge rotates. The cardio-fitness equipment may be an exercise bicycle

The cardio-fitness equipment can be suitably configured for operation when the rotate-able portion of the hinge apparatus is secured to the body portion of the hinge apparatus at a first hinge location and when the first portion of the cardio-fitness equipment is in a first position. In addition, the cardio-fitness equipment can be suitably configured for a reduced-dimension purpose when the rotate-able portion is rotated from the first hinge location to a second hinge location and when the first portion of the cardio-fitness equipment is in a second position. In one embodiment, the first portion of the cardio-fitness equipment reaches the second position when rotated away from a seat of the cardio-fitness equipment.

The reduced-dimension purpose can include by way of example but not limitation, one or more of, packaging, shipping, and/or storage. The cardio-fitness equipment can have at least one reduced dimension when in the second position relative to when in the first position. In one embodiment, The cardio-fitness equipment may have an increased dimension when in the second position relative to when in the first position.

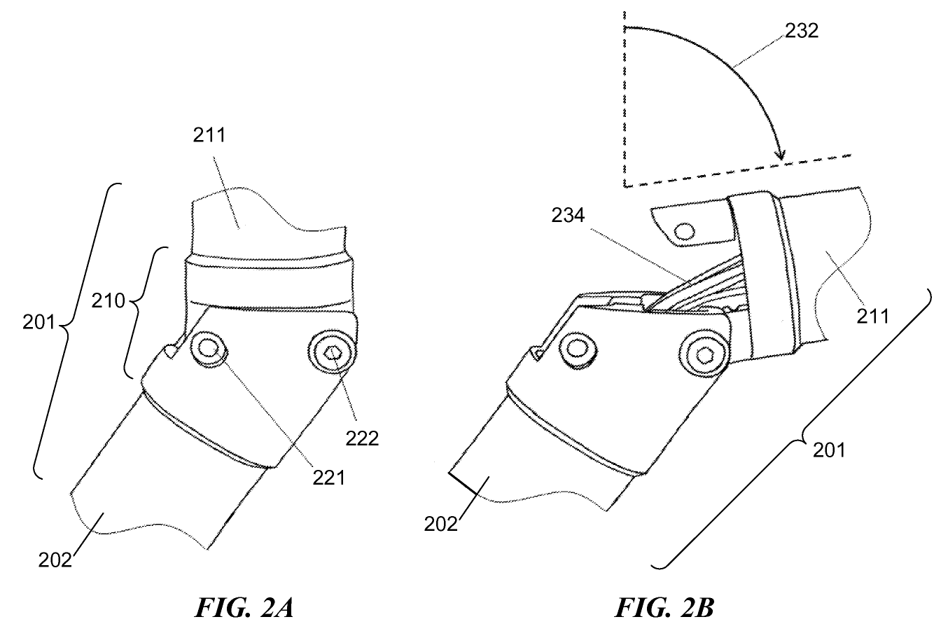

The configuration and operation of the hinge apparatus/assembly 110 in the example of FIG. 1A-B is further illustrated in the example of FIG. 2A-B.

FIG. 2A depicts the physical configuration of a hinge 210 that enables position adjustment of equipment, the hinge 210 is positioned in a first hinge position that is suitable for operation of the equipment, according to one embodiment.

One embodiment of the equipment includes the hinge 210 adjoining a second portion 202 of the equipment with the first portion 211 of the equipment. One embodiment of the hinge 210 comprises a first securing mechanism and a second securing mechanism, For example, the first and second securing mechanism may comprise of bolts 221 and 222, respectively. Bolt 221 may be a locking bolt and bolt 222 may be a hinge bolt 222. In one embodiment, the bolts 221 and 222 are positioned along or approximately along the geometric axis of the hinge. When the bolt 221 (at least one) is secured, the two parts of the frame 202 and 211 can be held in place. In one embodiment, when the bolt 221 is secured, the equipment (e.g., exercise equipment 100 of FIG. 1A-B or other types of equipments) is maintained in a first position. This first position is typically suitable for the equipment to operate. Note that although two bolts 221 and 222 are illustrated, additional or less numbers may be used for similar or varying purposes.

FIG. 2B depicts the physical configuration of a hinge 210 positioned in a second hinge position configured to place the equipment in a second position, according to one embodiment.

In one embodiment, to adjust the position of the equipment attached to the frame 201, the hinge 210 is detachable on one side whereas the other side remains attached. For example, one side of the hinge 210 can be detached via loosening the bolt 221. A portion of the hinge 210 can thus be rotated about the bolt 222 causing the upper portion 211 of the equipment to rotate based on the movement of the hinge 210.

The first portion 211 can be rotated (e.g., folded) towards the second portion 202 of the equipment. The first portion 211 can be rotated over any suitable angle, for example, anywhere between but not limited to 90-245 degrees. In one embodiment, the first portion is 211 is rotated anywhere between 180-245 degrees but more preferable between around 200-220 degrees to ensure sufficient height reduction of the equipment through position adjustment. In one embodiment, the rotation angle is less than 90 degrees and greater than 30 degrees.

Note that the hinge 210 includes a through-hole. The electrical wires or connections 234 that power or otherwise facilitate the function of the associated equipment can be disposed in the through-hole and extend through the through-hole. In one embodiment, the hinge 210 is operatively configured such that the electrical wires and/or connections 234 remain intact or substantially intact (e.g., will not be cut or otherwise damaged, etc.) when the rotate-able portion of the hinge 210 rotates.

For example, the electrical signals running through the electrical wires will generally not be disrupted before, during, and/or after rotation of the rotate-ale portion of the hinge 210. The electrical signals will not be disrupted or disconnected because the electrical wires running through the through-hole will remain intact or substantially intact.

For example, the electrical connections or wires 234 passing though the frame 201 of the equipment remain connected while the hinge 210 is open as illustrated in FIG. 2B. Thus, the electrical connections in the equipment made at manufacturing stage remain connected during subsequent disassembly or reassembly processes to store, package, or ship the equipment.

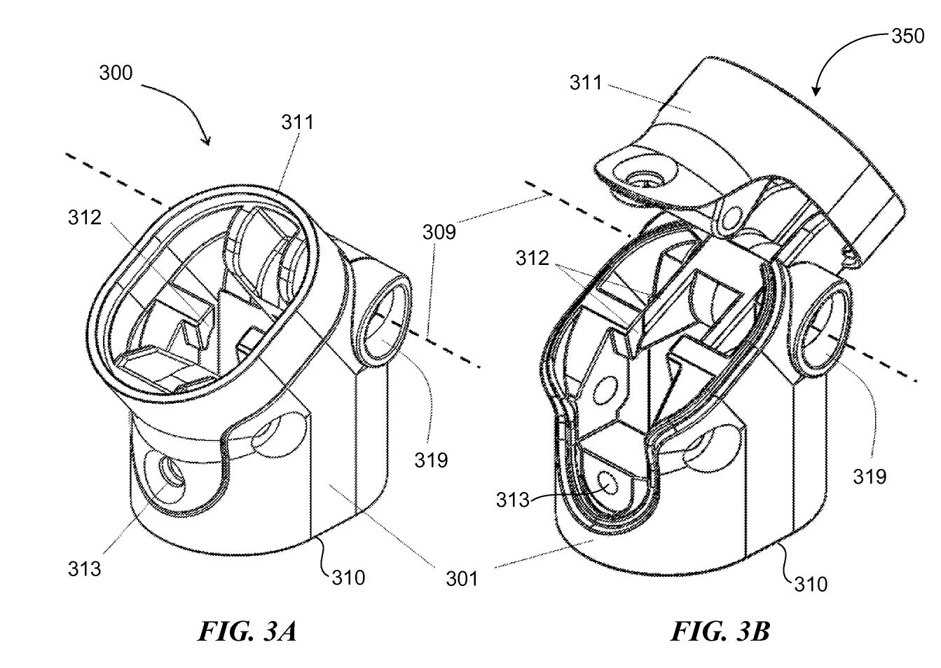

FIG. 3A depicts a further view of an example of the hinge 310 in a first hinge position 300 that is suitable for operation of the equipment, according to one embodiment.

One embodiment of the hinge 300 includes a body 301, a rotate-able portion 311, and/or a through-hole. The rotate-able portion 311 is typically coupled to a first portion of the equipment intended to be rotate-able or otherwise movable with the moving motion of the rotate-able portion 311 of the hinge assembly 310. In the example of exercise equipment, the rotate-able portion 311 is coupled to the first portion of the exercise equipment (e.g., the first portion 111 of equipment 100) in the example of FIG. 1A-1B.

The body 301 is typically attached to a second portion of the equipment that is intended to be stationary during assembly and/or disassembly via the hinge 310. For example, the hinge body 301 of the hinge 310 is coupled to the second portion of the exercise equipment (e.g., portion 108 of the frame 101) in the example of FIG. 1A-B.

In the example of FIG. 3A, the rotate-able portion 311 of the hinge 310 has not been rotated and is positioned in a first position. When the rotate-able portion 311 is in the first hinge position 300, it can be secured to the hinge 310, for example, via a securing/locking mechanism. One embodiment of the hinge 310 comprises a first securing mechanism 319 disposed along a rotational axis 309 of the hinge apparatus about which the rotate-able portion is able to rotate and a second securing mechanism 313 use-able to secure the rotate-able portion 311 to the body portion 301.

In one embodiment, the second securing mechanism 313 comprises an opening. A bolt (e.g., a locking bolt) can be inserted via the opening 313 to secure/lock the rotate-able portion 311 to the hinge 310 in the first hinge position 300. Typically, the attached equipment is in an operable position when the rotate-able portion 311 is placed in the first position and secured.

One embodiment of the first security mechanism 319 includes another opening where another bolt (e.g., bolt 222 (or, hinge bolt) in the example of FIG. 2) can be inserted and subsequently secured, for example, during assembly or equipment maintenance. In one embodiment, the bolt (not shown) is inserted into the hinge 310 in a direction that is parallel to or substantially parallel to (e.g., within ±5-10 degrees although preferably within ±5 degrees) the geometrical axis 309 of the hinge 310. The geometrical axis of the hinge is indicated with dashed lines 309. Additional openings for bolt placement can be included.

Any suitable number of bolts can be used to tighten the hinge. In one embodiment, one or two bolts are used to tighten and/or secure the hinge 310 and can be used as hinge bolts about which the rotate-able portion 311 of the hinge 310 can rotate. An illustration of the hinge assembly 310 when the rotate-able portion 311 has been rotated from the first hinge position to a second hinge position is illustrated with further reference to FIG. 3B.

FIG. 3B depicts a further view of an example of the hinge 310 positioned in a second hinge position 350 that is suitable for at least partially disassembling the equipment, according to one embodiment.

The rotate-able portion 311 of the hinge 310 can be rotated to a second hinge position or one or more additional predetermined positions or locations. When the rotate-able portion 311 is rotated, the portion of the equipment that is attached to the portion 311 rotates or otherwise moves in conjunction with the movement of portion 311 to the predetermined location.

Typically, when the portion of the equipment that is attached to rotate-able portion 311 rotates to the predetermined position or location, one or more dimensions of the overall size of the equipment are reduced (e.g., lesser height, lesser length, and/or lesser depth). In this second position, the equipment can generally be more efficiently stored, packaged, shipped, and or other processes/activities where there is limited amount of space.

In one embodiment, the second hinge position or the one or more additional predetermined locations is determined by a physical construct disposed within or otherwise coupled to the hinge 310. For example, the physical construct may be a hard stop 312 that is disposed inside the hinge 310. The hard stop 312 typically allows the rotate-able portion 311 to rotate up to a predetermined angle. In one embodiment, the hinge 310 comprises at least one washer. The washer may be a Belleville washer, also referred to as a cupped spring washer.

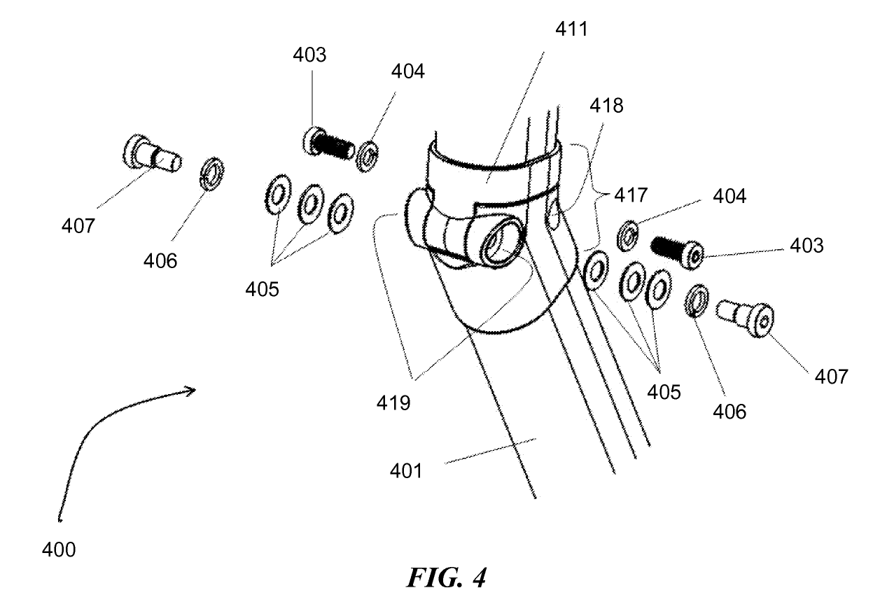

The washer can be disposed on a bolt as illustrated with further reference to the example in FIG. 4. Although one physical construct is illustrated, it is appreciated that additional constructs may be used to configure the predetermined locations that the rotate-able portion 311 can rotate to.

FIG. 4 depicts an exploded view of an example of the hinge assembly 400, according to one embodiment.

This example illustrates a set of example components in the hinge assembly 400. One embodiment of the hinge assembly 400 includes a hinge 417. The hinge 417 can include at least one bolt 407 (e.g., a hinge bolt) about which the rotate-able portion 411 of the hinge 417 can rotate. In addition, the bolt 407 can be optionally secured to the hinge 417 via a washer 406. In one embodiment, additional washers 405 (e.g., spring washers) are used to further secure the bolt 407 to the hinge 417. In one embodiment, the washers 405 are disposed adjacent to the hinge 417 and the washer 406 is disposed between the washers 405 and the bolt 407. Any number of washers 405 and 406 may be used.

The bolt 407 and optional washers 405 and/or 406 are inserted into the hinge 417 into the appropriate opening 419 and tightened/secured. One embodiment of the hinge assembly 400 includes two hinge bolts 407. The two hinge bolts 407 may be located on each side of the hinge 417. In addition, the two hinge bolts 407 may be optionally coupled to the hinge 417 via washers. Any type of washers may be used including but not limited to spring washers. In addition, any suitable number of washers may be used although preferably 2-5. The washers provide friction to the rotational motion of the rotate-able portion 411 of the hinge assembly 400 relative to the lower portion 401 of the attached equipment. Therefore, the assembly/de-assembly process typically requires force application to rotate the rotate-able portion 411 due to the friction introduced by the spring washers (e.g., Belleville washers).

The hinge assembly 400 can further be secured by bolt 403 (e.g., a locking bolt). The bolt 403 can be secured to the hinge 417 via optional washers 404. The bolt 403 can be inserted into locking opening 418 and subsequently secured and tightened. Typically, the bolt 403 is used to secure the hinge to prevent movement of the equipment such that it can be used and/or otherwise operated. In one embodiment, the bolt 403 is used to secure the associated equipment (e.g., fitness or other types of equipment) in a first position suitable for operation of the associated equipment. For example, in the situation that the equipment is exercise equipment, users can safely exercise on or use the equipment when the bolt 403 is secured.

The hinge assembly 400 further advantageously enables a person to rotate (e.g., fold/unfold or otherwise move) a portion of the associated equipment for assembly and/or disassembly for various purposes without danger of damaging the equipment or hurting oneself.

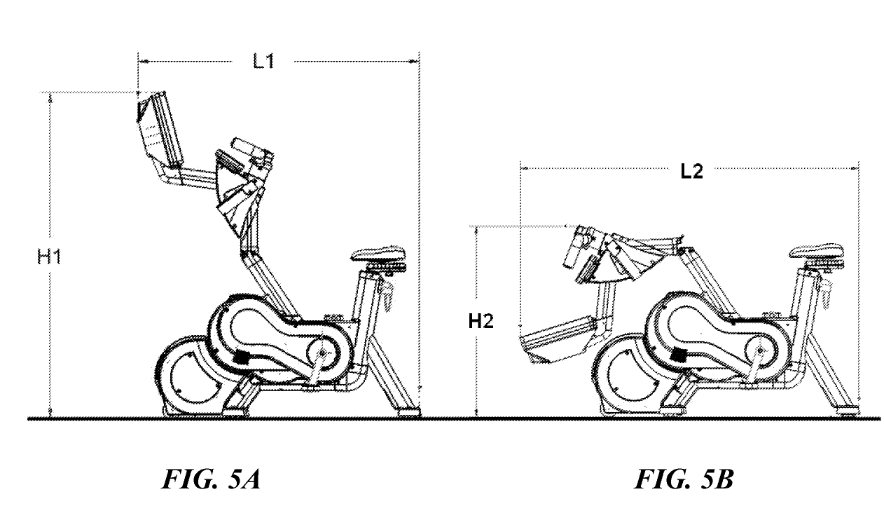

FIG. 5A depicts another view of an example equipment having the hinge assembly in a first hinge position that is suitable for operation of the equipment, according to one embodiment.

When the hinge assembly is in a first hinge position, the equipment is typically placed in the first position and is typically secured from moving or rotating and suitable for operation. In the first position, the equipment has a height represented by H1 and a length represented by L1. The dimension designations are illustrated with reference to the examples of FIG. 5A in the first position.

The height H1 and/or the length L1 can be reduced when the equipment is position adjusted via a hinge apparatus/assembly (e.g., the hinge apparatus/assembly of the examples of FIG. 3-4). For example, the equipment can be position adjusted into a second position when the hinge assembly is in a second hinge position, as illustrated with further reference to FIG. 5B.

FIG. 5B depicts another view of the example equipment having a hinge assembly in a second hinge position that is suitable for at least partially disassembling the equipment, according to one embodiment.

When the hinge assembly is in a second hinge position, the equipment is typically placed in the second position. In the second position, the equipment has a height represented by H2 and a length represented by L2. The reduced height and/or length of the equipment in the second position allows the equipment to be used in applications where space is limited, for example, when placing the equipment in storage space, packaging, and/or shipping.

For example, the equipment can be shipped when it has a smaller height denoted with H2.

In the example of FIG. 5A-B, when a portion of the equipment has been rotated from its first position for operation, the length of the station may be increased from L1 to L2. Note that although the height is illustrated to decrease, it is appreciated that for other equipments, additional, similar, or same dimensions may decrease via the hinging mechanism introduced by the hinge assembly. For example, any or all of the height, the length, and/or the depth may be reduced depending on the particular equipment and the direction of rotation the hinge assembly is capable of and is considered to be within the scope of the disclosure.

The equipment for intermodal freight transport is so called intermodal containers. Their dimensions have been defined by the ISO standard body and hence sometimes these containers are referred to as ISO containers. ISO standards allow multiple container heights: eight feet and six inches (8′6″) is most common outside dimension that allows seven feet and ten inches (7′10″) inside room for stacking merchandise.

In one embodiment, the choice of the height H2 in the second position is selected to allow two folded equipments to be packed and stacked one on top of each other for transportation in an ISO container. For example, the height H2 is approximately 35″, or 35″±10%. This feature increases packing density and reduces the packaging requirements and cost, and hence reduces the shipping costs relative to the costs associated with potential packaging and shipping of the completely-assembled station in the normal-operating configuration. It is clear that packing and transporting the equipment (e.g., fitness or other types of equipment) using the hinge assembly in containers with interior height different than above-given example of seven feet and ten inches is possible.

In one embodiment, the equipment folds forward from a first position having a height of over 150 cm to a second position having height less than 89 cm above the ground.

Note that the assembly of the shipped equipment according to present disclosure at the destination is simple: It requires rotating a portion of the equipment (unfolding) and securing the equipment at the hinge. Any securing mechanism can be used including but not limited to, tightening of one or two locking bolts.

Further, the assembly process typically does not require re-wiring or un-wiring electrical connections within the equipment since most or all of the electrical connections have been made before packaging and/or shipping of the equipment.

Note that the novel spirit of the disclosure can be applied to various types of equipment or exercise equipment (e.g., upright and/or recumbent). For example, in a recumbent exercise bicycle, having a monitor attached to a foldable part of the frame can be rotated via the hinge assembly thereby reducing the overall height of the equipment for shipping or any other purposes.

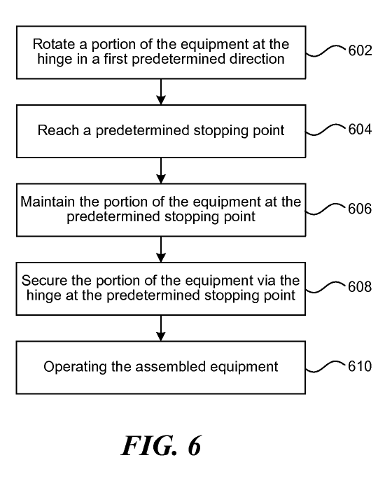

FIG. 6 illustrates an example process flow for equipment assembly using a hinge, according to one embodiment.

In process 602, a portion of the equipment is rotated at the hinge in a first predetermined direction. The equipment may be any equipment including but not limited to exercise equipment and cardio-fitness equipment, and/or any other equipment with electrical connections. The first predetermined direction can be any direction (left, right, up, down, horizontal, vertical, clockwise, and/or counter-clockwise) that facilitates assembly of the equipment. In process 604, a predetermined stopping point is reached via the rotational movement.

In process 606, the portion of the equipment is maintained at the predetermined stopping point. In one embodiment, the predetermined stopping point of the portion of the equipment is a position at which the equipment is able to be operated or otherwise used. In the case of exercise equipment, users can typically exercise when the equipment is in this position defined by the predetermined stopping point. The predetermined stopping point may be determined via a physical construct in the hinge or any other suitable mechanism using hardware and/or software.

In process 608, the portion of the equipment is secured via the hinge at the predetermined stopping point. For example, the portion of the equipment may be secured/locked by bolting a rotate-able portion of the hinge to a body portion of the hinge. Other types of locking/securing mechanisms maybe used. In process 610, the assembled equipment can be optionally operated and/or used. For example, a user can now safely exercise on the exercise equipment.

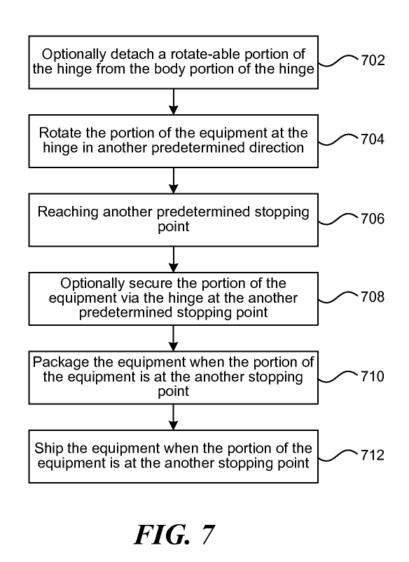

FIG. 7 illustrates an example process flow for equipment de-assembly using a hinge, according to one embodiment.

In process 702, a rotate-able portion of the hinge is optionally detached from the body portion of the hinge. In one embodiment, the detaching the rotate-able portion from the body portion comprises un-bolting the rotate-able portion from the body portion. Other detaching mechanisms may be used. In process 704, the portion of the equipment is rotated at the hinge in another predetermined direction.

In process 706, another predetermined stopping point is reached. Another predetermined stopping point may be determined via a physical construct in the hinge. The physical construct can be but is not limited to the hard stop or other types of stoppers within or otherwise coupled to the hinge.

In process 708, the portion of the equipment is secured via the hinge at another predetermined stopping point, for example, via a bolting or some other locking mechanism. In process 710, the equipment can be packaged when the portion of the equipment is at another stopping point. In process 712, the equipment can be shipped when the portion of the equipment is at the another stopping point.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other methods, devices, and/or systems, not necessarily to those described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the device may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated.

In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. Accordingly, the inventors reserve the right to add additional claims after filing the application to pursue such additional claim forms for other aspects of the disclosure.

What is claimed is:

1. An exercise apparatus, comprising,
a hinge apparatus having a through-hole, the hinge apparatus comprising a rotate-able portion and a body portion;
cardio-fitness equipment having:
a first portion coupled to the rotate-able portion of the hinge apparatus;
a second portion coupled to the body portion of the hinge apparatus; and
an electrical wire that facilitates function of the cardio-fitness equipment; wherein, the electrical wire is disposed in the hinge extending through the through-hole;
wherein, the cardio-fitness equipment is suitably configured for operation when the rotate-able portion of the hinge apparatus is secured to the body portion of the hinge apparatus at a first hinge location and when the first portion of the cardio-fitness equipment is in a first position;
wherein, the cardio-fitness equipment is suitably configured for a reduced-dimension purpose when the rotate-able portion is rotated from the first hinge location to a second hinge location and when the first portion of the cardio-fitness equipment is in a second position;
wherein the hinge apparatus is operatively configured such that the electrical wire remains intact during when the rotate-able portion of the hinge rotates.

2. The exercise apparatus of claim 1, wherein, the reduced-dimension purpose comprises, one or more of, packaging, shipping, or storage.

3. The exercise apparatus of claim 1, wherein, the first portion of the cardio-fitness equipment reaches the second position when rotated away from a seat of the cardio-fitness equipment.

4. The exercise apparatus of claim 1, wherein, the cardio-fitness equipment has at least one reduced dimension when in the second position relative to when in the first position.

5. The exercise apparatus of claim 4, wherein, the cardio-fitness equipment has an increased dimension when in the second position relative to when in the first position.

6. The exercise apparatus of claim 1, wherein, the cardio-fitness equipment is an exercise bicycle.

7. A system, comprising,
a hinge apparatus having a through-hole, the hinge apparatus comprising a rotate-able portion and a body portion;
an equipment having:
a first portion coupled to the rotate-able portion of the hinge apparatus;
a second portion coupled to the body portion of the hinge apparatus; and
an electrical wire that facilitates function of the equipment;
wherein, the electrical wire is disposed in the hinge extending through the through-hole;
wherein the hinge apparatus is operatively configured such that the electrical wire remains intact during when the rotate-able portion of the hinge rotates.

8. The system of claim 7, wherein the equipment is exercise equipment.

9. The system of claim 8, wherein the equipment is cardio-fitness equipment.

10. The system of claim 8, wherein, the equipment is a bicycle, stepper, elliptical trainer, treadmill, or rower.

11. The system of claim 7, wherein, the first portion of the equipment is rotate-able between at least two positions comprising a first position and a second position.

12. The system of claim 8, wherein, the equipment has a reduced dimension when in the second position relative to when in the first position.

13. The system of claim 12, wherein, the reduced dimension of the equipment in the second position allows packing two of the equipments in an International Container; wherein the reduced dimension is not more than approximately 35″.

14. The system of claim 8, wherein the exercise equipment comprises a seat and a foot actuator.

15. The system of claim 14, wherein the exercise equipment further comprises, a display unit and a computing unit.

16. The system of claim 14, wherein the exercise equipment further comprises a steering member and a gear-shifting unit.

17. The system of claim 14, wherein the foot actuator comprises pedals or steppers.

18. The system of claim 7, further comprising,
a physical construct to limit motion of the rotate-able portion of the hinge apparatus;
a first securing mechanism disposed along a rotational axis of the hinge apparatus about which the rotate-able portion is able to rotate; and
a second securing mechanism use-able to secure the rotate-able portion to the body portion.

19. A hinge apparatus, comprising
a rotate-able portion;
a body coupled to the rotate-able portion along a rotational axis;
a first securing mechanism disposed along the rotational axis about which the rotate-able portion is able to rotate;
a second securing mechanism use-able to secure the rotate-able portion to the body; and
a through-hole through which at least one electrical connection extends; wherein the hinge apparatus is operatively configured such that the electrical connection remains intact during when the rotate-able portion rotates.

20. The hinge apparatus of claim 19, further comprising, a physical construct to limit motion of the rotate-able portion.

21. The hinge apparatus of claim 19, wherein the first and second securing mechanisms comprise first and second bolts.

22. The hinge apparatus of claim 21, further comprising, first and second washers coupled to the first and second bolts, respectively.

23. The hinge apparatus of claim 22, wherein the first and second washers are cupped spring washers.

24. A method of position adjustment for assembly of equipment having a hinge, comprising:
rotating a portion of the equipment at the hinge in a first predetermined direction until a predetermined stopping point is reached; and
securing the portion of the equipment via the hinge at the predetermined stopping point.

25. The method of claim 24, wherein the equipment is cardio-fitness equipment.

26. The method of claim 24, further comprising, maintaining the portion of the equipment at the predetermined stopping point prior to securing the portion of the equipment.

27. The method of claim 24, wherein, the predetermined stopping point of the portion of the equipment is a position at which the equipment is able to operate.

28. The method of claim 24, wherein, the predetermined stopping point is determined via a physical construct in the hinge.

29. The method of claim 24, wherein, the securing the portion of the equipment comprises bolting a rotate-able portion of the hinge to a body portion of the hinge.

30. A method of position adjustment for de-assembly of equipment having a hinge, comprising:
rotating the portion of the equipment at the hinge in another predetermined direction until another predetermined stopping point is reached;
wherein the another predetermined stopping point is a position at which the equipment has a smaller height or length.

31. The method of claim 30, further comprising, detaching a rotate-able portion of the hinge from a body portion of the hinge prior to rotating the portion of the equipment.

32. The method of claim 31, wherein, the detaching the rotate-able portion from the body portion comprises un-bolting the rotate-able portion from the body portion.

33. The method of claim 30, further comprising, optionally securing the portion of the equipment via the hinge at the another predetermined stopping point.

34. The method of claim 33, further comprising, packaging or shipping the equipment when the portion of the equipment is at the another stopping point.
